(19) United States
(12) Patent Application Publication
(10) Pub. No.: US 2026/0257309 A1
(43) Pub. Date: Sep. 3, 2026

(54) MACHINE TOOL, INFORMATION PROCESSOR, AND CONTROL PROGRAM

(71) Applicant: DMG MORI CO., LTD., NARA (JP)

(72) Inventor: Shuji YAMAMOTO, HOKKAIDO (JP)

(73) Assignee: DMG MORI CO., LTD., NARA (JP)

(21) Appl. No.: 19/163,818

(22) PCT Filed: Aug. 9, 2024
(86) PCT No.: PCT/JP2024/028700

§ 371 Date: Sep. 9, 2025

(30) Foreign Application Priority Data
Aug. 30, 2023 (JP) 2023-140031

(51) Int. Cl. B23Q 11/10; B23Q 11/00; B23Q 17/24; G05B 19/18

(52) U.S. Cl. CPC B23Q 11/1076; B23Q 11/005; B23Q 17/2409; B23Q 17/249; G05B 19/18; G05B 2219/49049; G05B 2219/49348; G05B 2219/50248

(57) ABSTRACT

A machine tool includes a nozzle, an actuator that operates the nozzle, and an actuator control unit that controls the actuator such that a discharge area to which a coolant is discharged from the nozzle moves along a cleaning path including a starting point and an end point and extending between the starting point and the end point. When discharging of the coolant from the nozzle is paused at a first position on the cleaning path the actuator control unit controls the actuator such that discharging of the coolant from the nozzle is resumed from a second position on the cleaning path which is (i) the starting point or (ii) a point located between the starting point and the first position.

### TECHNICAL FIELD

The present invention relates to a machine tool, an information processor, and a control program.

### BACKGROUND ART

For example, Japanese Patent Laying-Open No. 2021-102235 (PTL 1) discloses a machine tool including an imaging unit, a chip recognition unit that automatically recognizes chips based on an image captured by the imaging unit and detects a position at which the chips are accumulated, and a coolant ejection unit that, upon receipt of a detection signal input from the chip recognition unit, ejects a coolant along a predetermined path toward the position at which the chips are accumulated.

### CITATION LIST

### Patent Literature

PTL 1: Japanese Patent Laying-Open No. 2021-102235

### SUMMARY OF INVENTION

### Technical Problem

In the machine tool disclosed in PTL 1 above, upon detection of an area where chips are accumulated based on an image of a machining area captured by the imaging unit, automatic cleaning is performed to automatically eject a coolant toward the area where the chips are accumulated.

However, the case where automatic cleaning is temporarily paused is assumed when, for example, tools are changed by an automatic tool changer (ATC). In such a case, depending on how to resume automatic cleaning, cleaning effects may not be obtained sufficiently.

An object of the present invention is to provide a machine tool capable of performing the step of cleaning a machining area with a coolant so as to obtain sufficient cleaning effects, and an information processor and a control program used to control such a machine tool.

### Solution to Problem

A machine tool according to the present invention includes a nozzle that discharges a coolant to a machining area, an actuator that operates the nozzle, and an actuator control unit that controls the actuator such that a discharge area to which the coolant is discharged from the nozzle moves along a predetermined path including a starting point and an end point and extending between the starting point and the end point. When discharging of the coolant from the nozzle is paused at a first position on the predetermined path, the actuator control unit controls the actuator such that discharging of the coolant from the nozzle is resumed from a second position on the predetermined path, the second position being (i) the starting point or (ii) a point located between the starting point and the first position.

An information processor according to the present invention is an information processor for controlling a machine tool including a nozzle that discharges a coolant to a machining area and an actuator that operates the nozzle. The information processor includes an actuator control unit that controls the actuator such that a discharge area to which the coolant is discharged from the nozzle moves along a predetermined path including a starting point and an end point and extending between the starting point and the end point. When discharging of the coolant from the nozzle is paused at a first position on the predetermined path, the actuator control unit controls the actuator such that discharging of the coolant from the nozzle is resumed from a second position on the predetermined path, the second position being (i) the starting point or (ii) a point located between the starting point and the first position.

A control program according to the present invention is a control program for a machine tool including a nozzle that discharges a coolant to a machining area and an actuator that operates the nozzle. The control program causes the machine tool to perform the step of controlling the actuator such that a discharge area to which the coolant is discharged from the nozzle moves along a predetermined path including a starting point and an end point and extending between the starting point and the end point. The step of controlling the actuator includes the step of controlling the actuator such that when discharging of the coolant from the nozzle is paused at a first position on the predetermined path, discharging of the coolant from the nozzle is resumed from a second position on the predetermined path, the second position being (i) the starting point or (ii) a point located between the starting point and the first position.

### Advantageous Effects of Invention

According to the present invention, the machine tool capable of cleaning a machining area with a coolant so as to obtain sufficient cleaning effects can be provided, and the information processor and the control program used for controlling such a machine tool can be provided.

### BRIEF DESCRIPTION OF DRAWINGS

FIG. 1 is a perspective view of a machine tool in an embodiment of the present invention.

FIG. 2 is a top view showing a machining area of the machine tool in FIG. 1.

FIG. 3 is a top view showing a nozzle for automatic cleaning in FIG. 2 and an actuator for operating the nozzle.

FIG. 4 is a side view showing the nozzle for automatic cleaning in FIG. 2 and the actuator for operating the nozzle.

FIG. 5 is a top view showing an automatic cleaning cycle in the machine tool in FIG. 2.

FIG. 6 schematically shows a control system of a drive mechanism in the machine tool in FIG. 1.

FIG. 7 shows functional components of the control system of the machine tool in FIG. 1.

FIG. 8 is a flowchart showing a flow of the automatic cleaning cycle in the machine tool in FIG. 1.

FIG. 9 shows a cycle of pausing and resuming automatic cleaning.

FIG. 10 shows a cleaning path set in a first region.

FIG. 11 is a diagram showing the movement of a discharge area when automatic cleaning is paused and resumed in the cleaning path in FIG. 10.

FIG. 12 is another diagram showing the movement of the discharge area when automatic cleaning is paused and resumed in the cleaning path in FIG. 10.

FIG. 13 is still another diagram showing the movement of the discharge area when automatic cleaning is paused and resumed in the cleaning path in FIG. 10.

FIG. 14 is a diagram showing a modification of the movement of the discharge area when automatic cleaning is paused and resumed in the cleaning path in FIG. 10.

FIG. 15 is another diagram showing the modification of the movement of the discharge area when automatic cleaning is paused and resumed in the cleaning path in FIG. 10.

FIG. 16 shows a cleaning path set in a fourth region.

FIG. 17 is a diagram showing the movement of the discharge area when automatic cleaning is paused and resumed in the cleaning path in FIG. 16.

FIG. 18 is another diagram showing the movement of the discharge area when automatic cleaning is paused and resumed in the cleaning path in FIG. 16.

FIG. 19 is still another diagram showing the movement of the discharge area when automatic cleaning is paused and resumed in the cleaning path in FIG. 16.

### DESCRIPTION OF EMBODIMENTS

An embodiment of the present invention will be described with reference to the drawings. In the drawings referred to below, the same or corresponding elements have the same reference characters allotted.

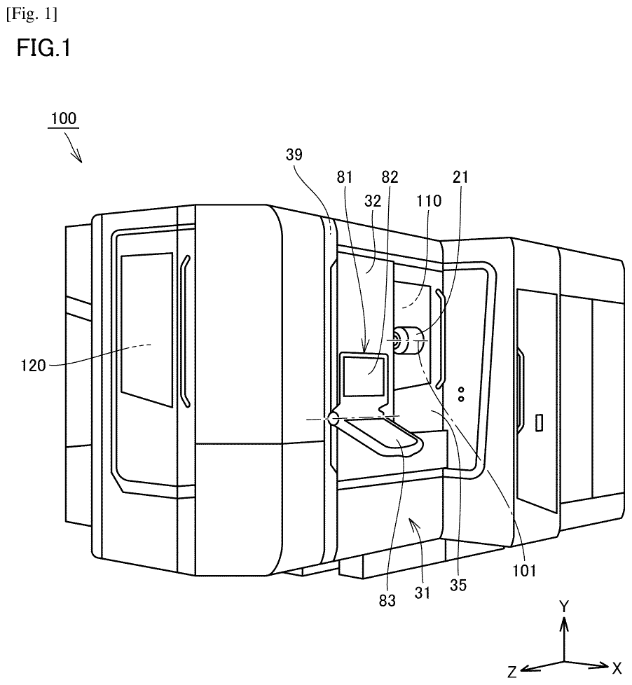

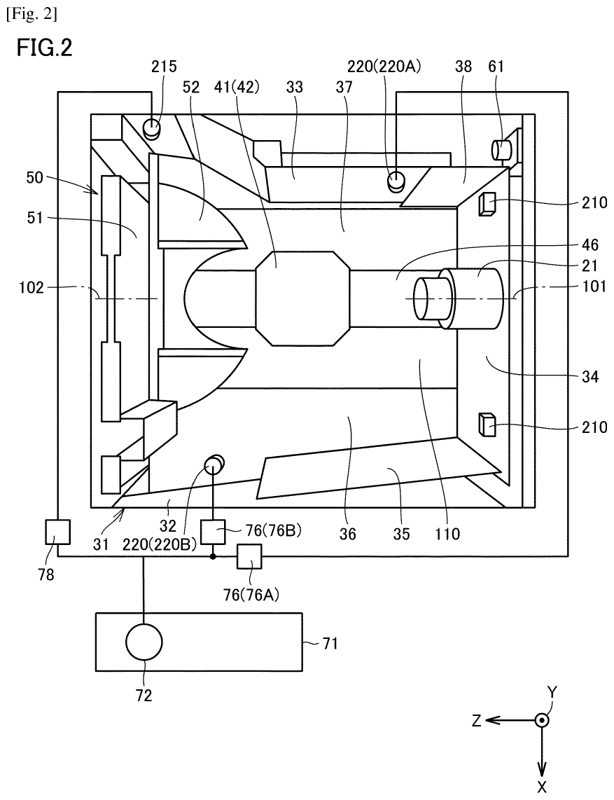

FIG. 1 is a perspective view of a machine tool in an embodiment of the present invention. FIG. 2 is a top view showing a machining area of the machine tool in FIG. 1.

Referring to FIGS. 1 and 2, a machine tool 100 is a machining center that machines a workpiece by bringing a rotating tool into contact with the workpiece, and more particularly, a horizontal machining center with a rotation center axis 101 of the tool extending horizontally. Machine tool 100 is a numerically controlled (NC) machine tool in which various operations for machining a workpiece are automated by numerical control using a computer.

The figures show a Z axis, which is parallel to the horizontal direction and parallel to rotation center axis 101 of the tool, an X axis, which is parallel to the horizontal direction and orthogonal to rotation center axis 101 of the tool, and a Y axis, which is parallel to the vertical direction.

Machine tool 100 includes a tool spindle 21. Tool spindle 21 is rotatable about rotation center axis 101 parallel to the Z axis by being driven by a motor. Tool spindle 21 has a built-in clamping mechanism for removably holding a tool. Tool spindle 21 rotates tools such as drills, reamers, or milling cutters about rotation center axis 101. Tool spindle 21 is movable in the X-axis direction and the Y-axis direction by various feed mechanisms, guide mechanisms, and servo motors.

Machine tool 100 further includes a table 41. Table 41 is a device for fixing a workpiece. A pallet 42 is removably attached to table 41. Table 41 is movable in the Z-axis direction by various feed mechanisms, guide mechanisms, and servo motors.

Machine tool 100 further includes an automatic pallet changer (APC) 50. Automatic pallet changer 50 changes pallet 42 between a machining area 110 and a setup station 120. Machining area 110 is the space where a workpiece is machined. Tool spindle 21 and table 41 are disposed in machining area 110. Setup station 120 is the space where a workpiece is attached to pallet 42. Setup station 120 is equipped with a pallet placement base (not shown), on which pallet 42 is placed.

Automatic pallet changer 50 includes an APC arm 52 and a turning cover 51. APC arm 52 is slidable in the Y-axis direction (vertically) and is turnable about a turning center axis 102 by 180°. Turning center axis 102 extends in the Y-axis direction. APC arm 52 ascends along the Y-axis direction to lift pallet 42 from each of table 41 and the pallet placement base. APC arm 52 turns by 180° about turning center axis 102 to change pallet 42 between work area 110 and setup station 120. APC arm 52 descends along the Y-axis direction to place pallet 42 on each of table 41 and the pallet placement base.

Turning cover 51 defines a boundary between machining area 110 and setup station 120. Turning cover 51, together with APC arm 52, turns by 180° about turning center axis 102.

Machine tool 100 further includes an automatic tool changer 61. Automatic tool changer 61 changes a tool attached to tool spindle 21.

Machine tool 100 further includes an operation panel 81. Operation panel 81 is a general-purpose computer. Operation panel 81 includes an upper panel 82 and a lower panel 83. Upper panel 82 includes a touch screen that displays, for example, manuals or various application screens or is operated when an application is used. Lower panel 83 includes a touch screen that displays the operating status of machine tool 100 or the machining status of the workpiece or is operated when machine tool 100 is operated, and an operation unit, such as a button or a switch, that is operated when machine tool 100 is operated.

Machine tool 100 further includes a cover body 31. Cover body 31 defines machining area 110 and forms the external appearance of machine tool 100. Machining area 110 is hermitically sealed by cover body 31 such that foreign matter such as chips or a coolant resulting from machining of a workpiece do not leak from machining area 110.

Cover body 31 includes a first cover 32, a second cover 33, a telescopic cover 34, a door 35, a first oil pan 36, a second oil pan 37, an ATC shutter 38, and a ceiling cover 39.

First cover 32, second cover 33, telescopic cover 34, and turning cover 51 are provided upright to surround machining area 110 from four sides. First cover 32 and second cover 33 are disposed to face each other in the X-axis direction. Telescopic cover 34 and turning cover 51 are disposed to face each other in the Z-axis direction. Ceiling cover 39 is disposed on the ceiling of machining area 110.

Door 35 is disposed in an opening provided in first cover 32. Door 35 is slidable such that the opening provided in first cover 32 is opened or closed. ATC shutter 38 is disposed in the opening in second cover 33. ATC shutter 38 is slidable such that the opening provided in second cover 33 is opened or closed. Automatic tool changer 61 is disposed on the side opposite to machining area 110 with ATC shutter 38 in between.

Telescopic cover 34 is configured to be deformable as tool spindle 21 moves in the X-axis direction and the Y-axis direction. Tool spindle 21 projects from telescopic cover 34 in the Z-axis direction.

First oil pan 36 and second oil pan 37 are disposed on the floor of machining area 110. First oil pan 36 and second oil pan 37 are spaced apart from each other in the X-axis direction. First oil pan 36 extends diagonally downward from the lower end of first cover 32 toward second oil pan 37. Second oil pan 37 extends diagonally downward from the lower end of second cover 33 toward first oil pan 36.

Machine tool 100 further includes a conveyor 46. Conveyor 46 is provided between first oil pan 36 and second oil pan 37 in the X-axis direction. Conveyor 46 extends in the Z-axis direction. Conveyor 46 carries chips, resulting from machining of a workpiece, out of machining area 110.

Machine tool 100 further includes a plurality of cameras 210. Cameras 210 may be charge coupled device (CCD) cameras or cameras of other types.

Cameras 210 are provided so as to capture images of machining area 110. Cameras 210 are provided in machining area 110. Cameras 210 are attached to ceiling cover 39. Cameras 210 are provided to be distant from each other in the X-axis direction. Cameras 210 may be attached to, for example, first cover 32 or second cover 33, not limited to ceiling cover 39. Three or more cameras may be provided, or one camera may be provided.

Machine tool 100 further includes a nozzle 220 (220A, 220B). Nozzle 220 is capable of discharging a coolant to machining area 110. Nozzle 220 is attached to ceiling cover 39. As will be described later in detail, nozzle 220, which is provided for automatic cleaning, automatically discharges the coolant to an area that is identified as a chip accumulation area based on images captured by cameras 210.

Nozzles 220A and 220B are provided to be distant from each other. Nozzles 220A and 220B are provided to be distant from each other in the X-axis-Z-axis plane. Nozzle 220A is provided at a position closer to second cover 33 than to first cover 32 in the X-axis direction. Nozzle 220A is provided at a position closer to telescopic cover 34 than to turning cover 51 in the Z-axis direction. Nozzle 220A is provided directly above second oil pan 37. Nozzle 220B is provided at a position closer to first cover 32 than to second cover 33 in the X-axis direction. Nozzle 220B is provided at a position closer to turning cover 51 than to telescopic cover 34 in the Z-axis direction. Nozzle 220B is provided directly above first oil pan 36.

The position at which nozzle 220 is provided is not particularly limited. Nozzle 220 may be attached to, for example, first cover 32 or second cover 33. Three or more nozzles 220 may be provided, or one nozzle 220 may be provided.

Machine tool 100 further includes a nozzle 215. Nozzle 215 is capable of discharging the coolant to machining area 110. Nozzle 215 is attached to ceiling cover 39. As will be described later in detail, nozzle 215, which is provided for cleaning a blind spot, discharges the coolant to the region of machining area 110 which is the blind spot that the coolant from nozzle 220 cannot reach.

Nozzle 215 is provided to be distant from nozzles 220A and 220B in the X-axis-Z-axis plane. As an example, nozzle 215 is provided at the corner where second cover 33 and turning cover 51 intersect in the top view shown in FIG. 2.

As the coolant is discharged from nozzle 220 and nozzle 215, chips accumulated in machining area 110 are washed away toward conveyor 46.

Machine tool 100 further includes a coolant tank 71, a pump 72, a valve 76 (76A, 76B), and a valve 78.

Coolant tank 71 is formed of a box body capable of storing a coolant. Coolant tank 71 is placed on the floor of a factory or the like where machine tool 100 is installed. A coolant is stored in coolant tank 71. Pump 72 is placed in coolant tank 71. Pump 72, when driven, delivers the coolant stored in coolant tank 71 toward nozzle 220 (220A, 220B) and nozzle 215.

Valve 76 is provided on the path of a pipe connecting pump 72 to nozzle 220. Valve 76 controls a coolant flow toward nozzle 220. The coolant is discharged from nozzle 220 as valve 76 is opened, and discharging of the coolant from nozzle 220 is stopped as valve 76 is closed. Valve 76A is provided on the path of a pipe connecting pump 72 to nozzle 220A. Valve 76B is provided on the path of a pipe connecting pump 72 to nozzle 220B.

Valve 78 is provided on the path of a pipe connecting pump 72 to nozzle 215. Valve 78 controls a coolant flow toward nozzle 215. The coolant is discharged from nozzle 215 as valve 78 is opened, and discharging of the coolant from nozzle 215 is stopped as valve 78 is closed.

The coolant flows toward nozzle 220A, nozzle 220B, and nozzle 215 may be controlled by on-off control of a pump for supplying a coolant toward each nozzle.

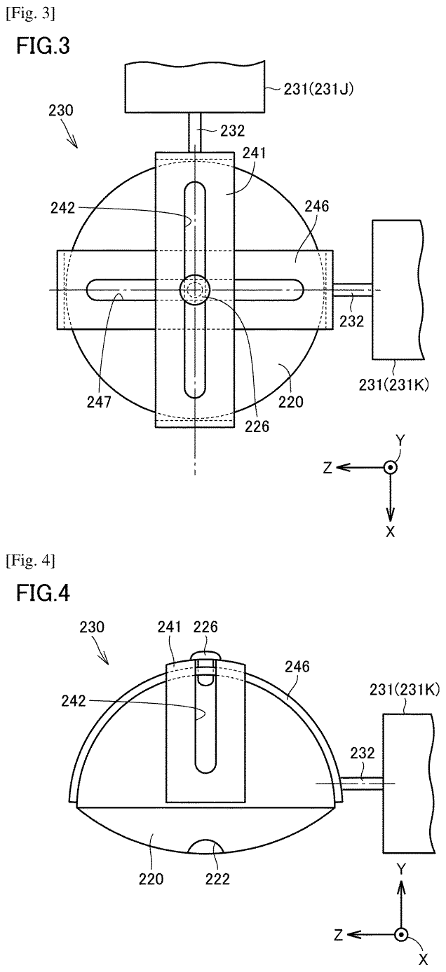

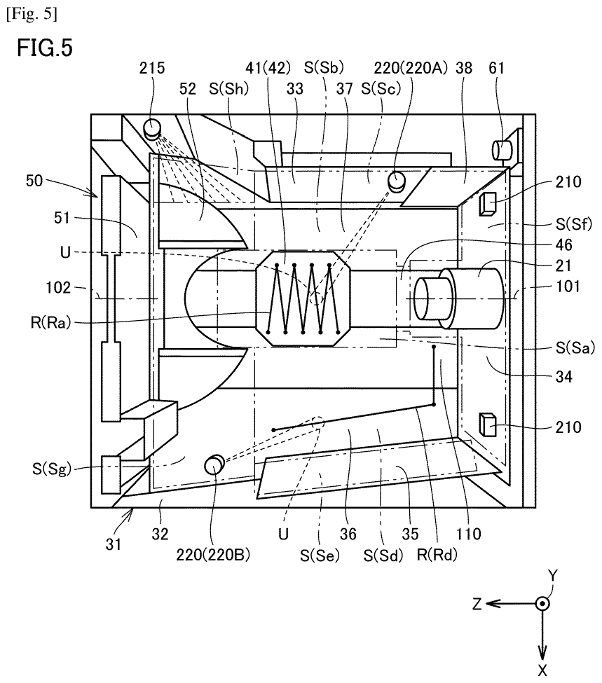

FIG. 3 is a top view showing a nozzle for automatic cleaning in FIG. 2 and an actuator for operating the nozzle. FIG. 4 is a side view showing the nozzle for automatic cleaning in FIG. 2 and the actuator for operating the nozzle. FIG. 5 is a top view showing an automatic cleaning cycle in the machine tool in FIG. 2.

Referring to FIGS. 3 to 5, machine tool 100 further includes an actuator 230. Actuator 230 operates nozzle 220. Actuator 230 operates nozzle 220 such that a discharge area U, to which the coolant is discharged from nozzle 220, moves.

More specifically, actuator 230 includes a motor 231 (231J, 231K), belts 241, 246, and a pin member 226.

Belts 241, 246 extend in an arc shape along the surface of nozzle 220. Belt 241 and belt 246 are provided to intersect each other in the top view shown in FIG. 3. Belt 241 has a long hole 242 extending along its longitudinal direction. Belt 246 has a long hole 247 extending along its longitudinal direction. Pin member 226 is inserted through long hole 242 and long hole 247 and is connected to nozzle 220.

Motor 231 is formed of a stepping motor. An output shaft 232 of motor 231J is connected to one end of belt 241. Output shaft 232 of motor 231J extends in the X-axis direction. Motor 231J outputs a rotational motion of forward or reverse rotation about the X axis to belt 241 via output shaft 232. With pin member 226 moving in long hole 247, nozzle 220 is drivingly rotated circumferentially about the X axis.

An output shaft 232 of motor 231K is connected to one end of belt 246. Output shaft 232 of motor 231K extends in the Z-axis direction. Motor 231K outputs a rotational motion of forward or reverse rotation about the Z axis to belt 246 via output shaft 232. With pin member 226 moving in long hole 242, nozzle 220 is drivingly rotated circumferentially about the Z axis.

Nozzle 220 is provided with a discharge port 222. Discharge port 222 is open in machining area 110. Nozzle 220 discharges the coolant from discharge port 222 to machining area 110. As nozzle 220 is drivingly rotated, the direction in which discharge port 222 opens, that is, the direction in which the coolant is discharged from nozzle 220, changes, causing discharge area U to move.

In the present invention, the structure of the actuator for operating the nozzle is not particularly limited. For example, the operation of the nozzle may be sliding or a combination of rotating and sliding. In these cases, a rail that linearly guides the nozzle and a motor that drivingly feeds the nozzle along the rail may be used. Motor 231 is not limited to a stepping motor and may be, for example, a servo motor.

Actuator 230 described above is not provided for nozzle 215 for cleaning a blind spot. The direction in which the coolant is discharged from nozzle 215 for cleaning a blind spot is fixed.

As shown in FIG. 5, in machine tool 100, a plurality of regions S are set in machining area 110. Regions S include a first region Sa, a second region Sb, a third region Sc, a fourth region Sd, a fifth region Se, a sixth region Sf, a seventh region Sg, and an eighth region Sh.

First region Sa mainly corresponds to the movement area of table 41 (pallet 42) and extends in a belt shape in the Z-axis direction. Second region Sb mainly corresponds to second oil pan 37. Third region Sc mainly corresponds to second cover 33 and ATC shutter 38. Fourth region Sd mainly corresponds to first oil pan 36. Fifth region Se mainly corresponds to door 35. Sixth region Sf mainly corresponds to telescopic cover 34 and tool spindle 21. Seventh region Sg mainly corresponds to APC arm 52, and first oil pan 36 and second oil pan 37 around APC arm 52. Eighth region Sh mainly corresponds to second oil pan 37 at the corner where second cover 33 and turning cover 51 intersect.

First region Sa, second region Sb, third region Sc, fourth region Sd, fifth region Se, sixth region Sf, and seventh region Sg are cleaned with the coolant from nozzle 220 for automatic cleaning. As an example, nozzle 220A is responsible for automatic cleaning of first region Sa, second region Sb, third region Sc, and sixth region Sf, and nozzle 220B is responsible for automatic cleaning of fourth region Sd, fifth region Se, and seventh region Sg.

A cleaning path R is set in each region S of first region Sa, second region Sb, third region Sc, fourth region Sd, fifth region Se, sixth region Sf, and seventh region Sg. In FIG. 5, a cleaning path Ra, which is set in first region Sa, and a cleaning path Rd, which is set in fourth region Sd, are representatively shown. As nozzle 220 is drivingly rotated by actuator 230, discharge area U to which the coolant is discharged from nozzle 220 moves along cleaning path R. Cleaning path R is a path extending between a starting point Ps and an end point Pg, which will be described later, and discharging of the coolant from nozzle 220 starts at starting point Ps and ends at end point Pg.

Eighth region Sh is a region that is a blind spot from the area to which the coolant is discharged from nozzle 220, and is cleaned with the coolant from nozzle 215 for cleaning a blind spot.

The number or positions of regions S defined in machining area 110 can be determined as appropriate in consideration of the shape of cover body 31 in machining area 110 or the tendency of the range where chips are accumulated along with particular machining of a workpiece.

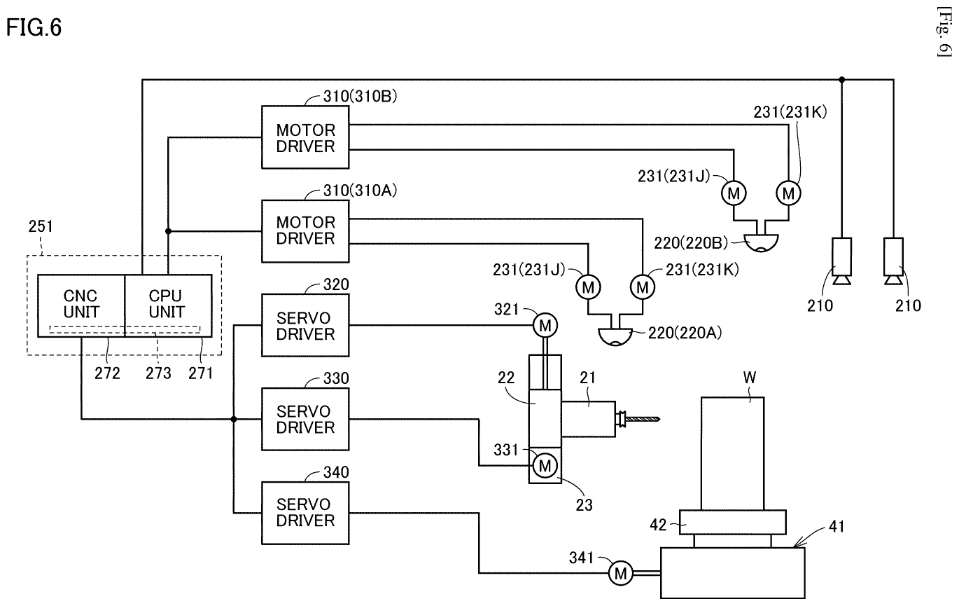

FIG. 6 schematically shows a control system of the drive mechanism in the machine tool in FIG. 1. Referring to FIG. 6, machine tool 100 further includes a controller 251, a motor driver 310 (310A, 310B), and servo drivers 320, 330, 340.

Controller 251 is a device that controls machine tool 100. Controller 251 may have any device configuration and may consist of a single control unit or a plurality of control units.

In FIG. 6, as an example, controller 251 consists of a CPU unit 271 serving as a programmable logic controller (PLC), and a CNC unit 272. CPU unit 271 and CNC unit 272 communicate with each other via a communication path 273 (e.g., a field bus or a LAN cable).

CPU unit 271 controls the various units constituting controller 251 according to a PLC program designed in advance. The PLC program is described, for example, in a ladder program. CPU unit 271 controls motor driver 310 according to the PLC program to control driving control of nozzle 220 (220A, 220B).

CNC unit 272 executes a machining program designed in advance. The machining program is described, for example, in a numerical control (NC) program. CNC unit 272 controls servo drivers 320, 330, 340 according to the machining program to machine a workpiece W fixed to table 41.

In FIG. 6, motor driver 310A is shown as a two-axis integrated driver. Motor driver 310A receives, from CPU unit 271, inputs of a target rotation speed and a target rotation angle amount of motor 231J and inputs of a target rotation speed and a target rotation angle amount of motor 231K. Motor driver 310A outputs pulse signals corresponding to the input target rotation speeds and target rotation angle amounts to motors 231J, 231K.

Motor 231J outputs a rotational motion upon application of a pulse signal from motor driver 310A to drivingly rotate nozzle 220A circumferentially about the X axis. Motor 231K outputs a rotational motion upon application of a pulse signal from motor driver 310A to drivingly rotate nozzle 220A circumferentially about the Z axis. In this manner, motor driver 310A individually controls the driving rotation of nozzle 220A in the circumferential direction about the X axis and the driving rotation of nozzle 220A in the circumferential direction about the Z axis, thereby appropriately changing the direction in which the coolant is discharged from nozzle 220A toward machining area 110.

Similarly, motor driver 310B individually controls the driving rotation of nozzle 220B in the circumferential direction about the X axis and the driving rotation of nozzle 220B in the circumferential direction about the Z axis, thereby appropriately changing the direction in which the coolant is discharged from nozzle 220B toward machining area 110.

Servo driver 320 sequentially receives inputs of a target position from CNC unit 272 and controls servo motor 321. Servo motor 321 drivingly feeds a cross slide 22, to which tool spindle 21 is attached, via ball screws (not shown) to move tool spindle 21 to any position in the Y-axis direction.

Servo driver 330 sequentially receives inputs of a target position from CNC unit 272 and controls servo motor 331. Servo motor 331 drivingly feeds a column 23, to which cross slide 22 is attached, via ball screws (not shown) to move tool spindle 21 to any position in the X-axis direction.

Servo driver 340 sequentially receives inputs of the target position from CNC unit 272 and controls servo motor 341. Servo motor 341 drivingly feeds table 41 via ball screws (not shown) to move table 41 to any position in the Z-axis direction.

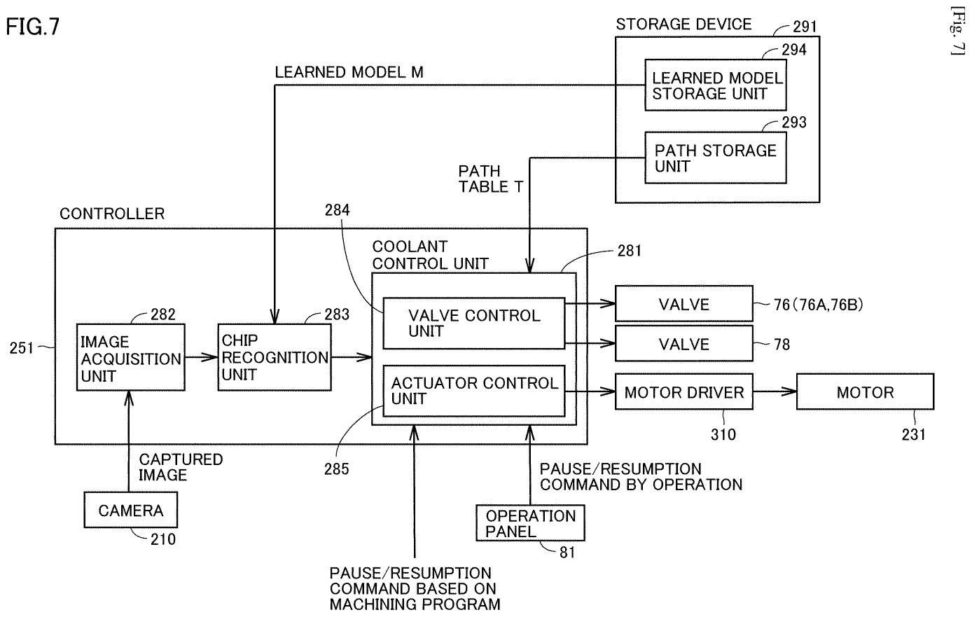

FIG. 7 shows functional components of the control system of the machine tool in FIG. 1. Referring to FIG. 7, machine tool 100 includes a storage device 291 and controller 251 as main hardware components.

Storage device 291 is, for example, a storage medium such as a hard disk or flash memory. Storage device 291 includes a learned model storage unit 294 and a path storage unit 293. Learned model storage unit 294 stores a learned model M, which will be described later. Path storage unit 293 stores a path table T. Path table T shows cleaning path R (Ra to Rg) which is set in each region S of first region Sa, second region Sb, third region Sc, fourth region Sd, fifth region Se, sixth region Sf, and seventh region Sg, and along which, discharge area U to which the coolant is discharged from nozzle 220 moves.

A control program for machine tool 100, which will be described later, is further stored in storage device 291.

Controller 251 includes an image acquisition unit 282, a chip recognition unit 283, and a coolant control unit 281 as functional components. The above functional components may be implemented in CPU unit 271 described above or in CNC unit 272 described above.

The above functional components may be implemented in an information processor prepared separately from CPU unit 271 and CNC unit 272. The information processor is a general-purpose computer. As an example, the information processor may be a desktop computer, a notebook computer, or a tablet terminal. The information processor may communicate with CPU unit 271 and/or CNC unit 272 using communication means such as wireless LAN, wired LAN, or field network.

Image acquisition unit 282 acquires an image of machining area 110 captured by camera 210. Image acquisition unit 282 outputs the acquired image to chip recognition unit 283.

Chip recognition unit 283 recognizes an accumulation area where chips are accumulated in machining area 110 based on the image of machining area 110 input by image acquisition unit 282.

Chip recognition unit 283 reads learned model M from learned model storage unit 294. The chip accumulation area is recognized using learned model M. Learned model M is generated in advance by a learning process using a learning dataset. The learning dataset includes a plurality of learning images in which chips are shown. Each learning image is associated with a label indicating whether chips are in the image. The internal parameters of learned model M are optimized in advance by the learning process using such a learning dataset.

Various machine learning algorithms can be employed in the learning method for generating learned model M. As an example, deep learning, convolutional neural networks (CNN), fully convolutional neural networks (FCN), support vector machines, and the like are employed as such machine learning algorithms.

Learned model M receives an input of an image obtained from camera 210 and outputs the position of chips in the image.

More specifically, chip recognition unit 283 divides the image into a plurality of mesh regions and inputs a partial image of each region to learned model M. As a result, learned model M outputs the probability that the input partial image includes chips. Chip recognition unit 283 identifies the position of the partial image with a probability exceeding a predetermined value as the position of the chips.

Chip recognition unit 283 determines whether the identified chip position is included in any region S of first region Sa, second region Sb, third region Sc, fourth region Sd, fifth region Se, sixth region Sf, and seventh region Sg in FIG. 5. Chip recognition unit 283 recognizes region S including the identified chip position as the accumulation area where chips are accumulated in machining area 110. Chip recognition unit 283 outputs, to coolant control unit 281, region S recognized as the chip accumulation area among first region Sa, second region Sb, third region Sc, fourth region Sd, fifth region Se, sixth region Sf, and seventh region Sg.

Coolant control unit 281 controls the execution of automatic cleaning by discharging of the coolant from nozzle 220. Coolant control unit 281 further controls the execution of cleaning of the blind spot by discharging of the coolant from nozzle 215.

Coolant control unit 281 includes a valve control unit 284. Valve control unit 284 controls the operations of opening and closing valve 76 (76A, 76B) and valve 78.

More specifically, when coolant control unit 281 receives, from chip recognition unit 283, an input of any region S of first region Sa, second region Sb, third region Sc, and sixth region Sf as the chip accumulation area, valve control unit 284 opens valve 76A. When coolant control unit 281 receives, from chip recognition unit 283, an input of any region of fourth region Sd, fifth region Se, and seventh region Sg as the chip accumulation area, valve control unit 284 opens valve 76B. When automatic cleaning is completed, valve control unit 284 closes valve 76 (76A, 76B).

Valve control unit 284 operates valve 78 after the completion of automatic cleaning. Valve control unit 284 closes valve 78 after the completion of cleaning of the blind spot.

Actuator control unit 285 reads path table T from path storage device 293 and identifies cleaning path R set in region S to be automatically cleaned. Actuator control unit 285 controls actuator 230 (motor 231) such that discharge area U moves along the identified cleaning path R during execution of automatic cleaning.

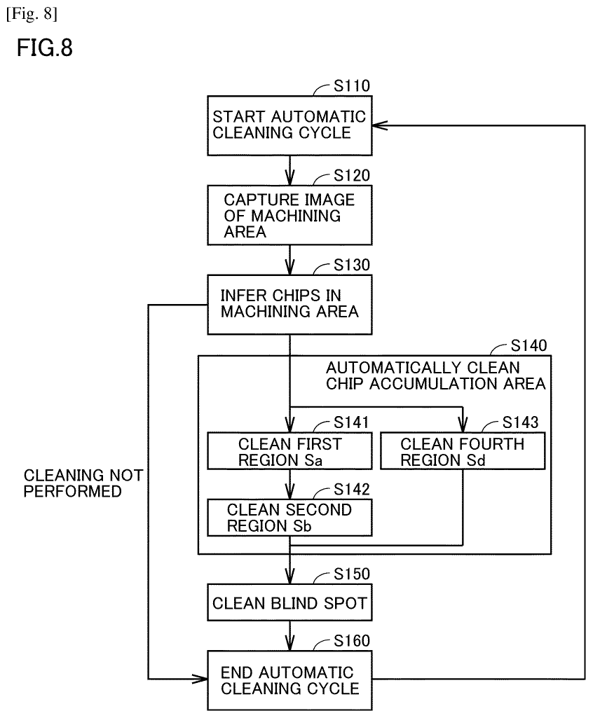

FIG. 8 is a flowchart showing a flow of an automatic cleaning cycle in the machine tool in FIG. 1.

Referring to FIGS. 7 and 8, controller 251 starts an automatic cleaning cycle for machining area 110 (S110). The automatic cleaning cycle may be started periodically or started upon the operator providing an instruction through control panel 81. Typically, the automatic cleaning cycle is started at regular intervals during machining of the workpiece.

Upon start of the automatic cleaning cycle in step S110, camera 210 captures an image of machining area 110 (S120). Image acquisition unit 282 acquires an image of machining area 110 captured by camera 210 and outputs the image to chip recognition unit 283.

Subsequently, chip recognition unit 283 infers chips in machining area 110 based on the input image of machining area 110 (S130). It is assumed in FIG. 8 that chip recognition unit 283 has recognized first region Sa, second region Sb, and fourth region Sd as chip accumulation areas. Chip recognition unit 283 outputs first region Sa, second region Sb, and fourth region Sd recognized as the chip accumulation areas to coolant control unit 281.

If none of regions S are recognized as the chip accumulation area in step S130, the automatic cleaning cycle ends without automatic cleaning and blind spot cleaning being performed (S160).

Subsequently, coolant control unit 281 automatically cleans the input first region Sa, second region Sb, and fourth region Sd (S140).

More specifically, valve control unit 284 opens valve 76A and valve 76B. Actuator control unit 285 controls actuator 230 (motor 231) such that discharge area U to which the coolant is discharged from nozzle 220A moves along cleaning path Ra set in first region Sa (S141). Following step S141, actuator control unit 285 controls actuator 230 (motor 231) such that discharge area U to which the coolant is discharged from nozzle 220A moves along cleaning path Rb set in second region Sb (S142). Valve control unit 284 closes valve 76A after the completion of steps S141 and S142.

In parallel with steps S141 and S142, actuator control unit 285 controls actuator 230 (motor 231) such that discharge area U to which the coolant is discharged from nozzle 220B moves along cleaning path Rd set in fourth region Sd (S143). Valve control unit 284 closes valve 76B after the completion of step S143.

Subsequently, coolant control unit 281 cleans a blind spot in eighth region Sh (S150). More specifically, valve control unit 284 opens valve 78. Valve control unit 284 closes valve 78 after the blind spot has been cleaned for a predetermined period of time. Through the steps described above, the automatic cleaning cycle ends (S160).

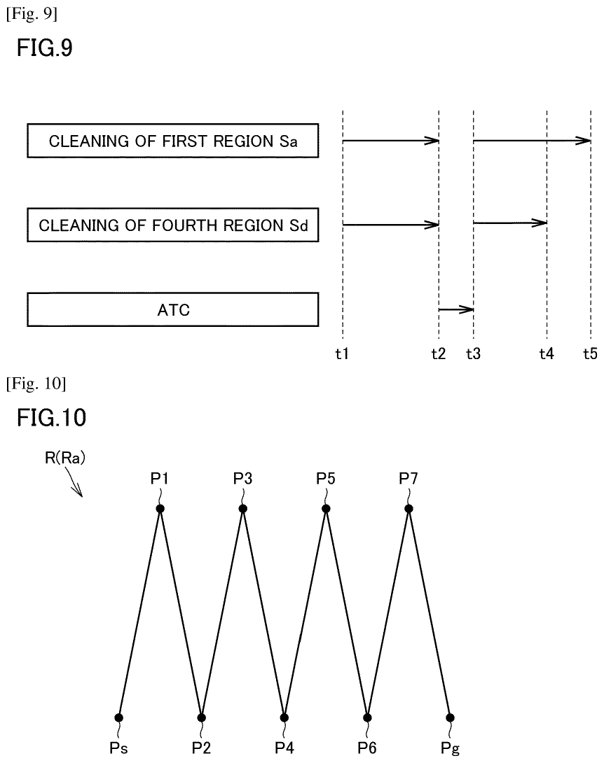

FIG. 9 shows a flow of the cycle of pausing and resuming automatic cleaning. Referring to FIGS. 7 to 9, coolant control unit 281 pauses/resumes discharging of the coolant from nozzle 220 upon receipt of an input of a command to pause/resume discharging of the coolant based on the machining program.

As an example, the machining program executed by CNC unit 272 includes an M06 command to instruct tool change by automatic tool changer 61. The command to pause discharging of the coolant is input to coolant control unit 281 in start of the execution of the M06 command, and the command to resume discharging of the coolant is input to coolant control unit 281 upon completion of the execution of the M06 command.

During tool change (ATC) by automatic tool changer 61, ATC shutter 38 is opened. Discharging of the coolant from nozzle 220 is temporarily paused to prevent the coolant from flowing out of machining area 110 into the space where automatic tool changer 61 is installed.

In the example shown in FIG. 9, at a time t1, automatic cleaning of first region Sa (S141) and automatic cleaning of fourth region Sd (S143) are started. At a time t2, when ATC is started, automatic cleaning of first region Sa and automatic cleaning of fourth region Sd are paused. At a time t3, upon completion of ATC, automatic cleaning of first region Sa and automatic cleaning of fourth region Sd are resumed. At a time t4, automatic cleaning of fourth region Sd is completed, and at a time t5, automatic cleaning of first region Sa is completed.

FIG. 10 shows a cleaning path set in the first region. Referring to FIG. 10, cleaning path Ra extends through starting point Ps, direction change points P1 to P7, and end point Pg in order. Starting point Ps is a position at which cleaning path Ra begins. End point Pg is a position at which cleaning path Ra ends. Cleaning path Ra extends in a zigzag manner between starting point Ps and end point Pg while changing its direction at each position of direction change points P1 to P7.

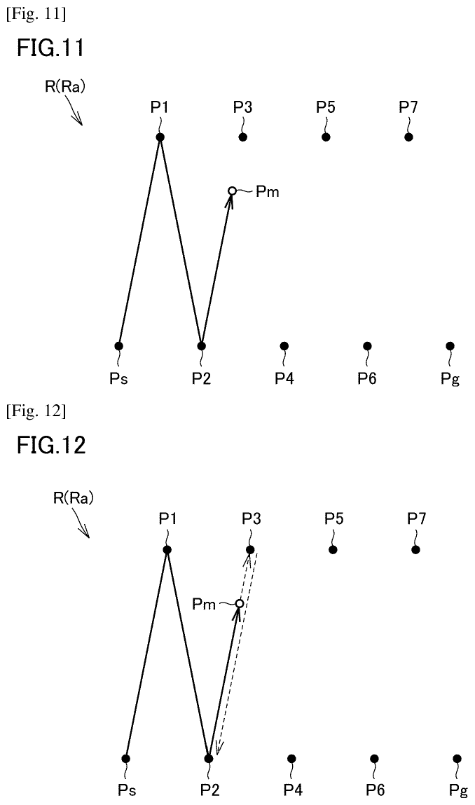

FIGS. 11 to 13 show the movements of the discharge area when automatic cleaning is paused and resumed in the cleaning path in FIG. 10.

Referring to FIGS. 11 to 13, actuator control unit 285 controls actuator 230 (motor 231) such that when discharging of the coolant from nozzle 220 (220A) is paused at a first position Pm on cleaning path Ra, discharging of the coolant from nozzle 220 (220A) is resumed from a second position Pn on cleaning path Ra. Second position Pn is (i) starting point Ps or (ii) a point located between starting point Ps and first position Pm. Starting point Ps and first position Pm are not included between starting point Ps and first position Pm in (ii).

As shown in FIG. 11, actuator control unit 285 drivingly rotates nozzle 220A such that discharge port 222 of nozzle 220A faces starting point Ps on cleaning path Ra. Valve control unit 284 opens valve 76A. Actuator control unit 285 drivingly rotates nozzle 220A such that discharge port 222 faces starting point Ps, direction change point P1, and direction change point P2 on cleaning path Ra in order. As a result, with the coolant being discharged from nozzle 220A, discharge area U to which the coolant is discharged from nozzle 220A moves in a zigzag manner through starting point Ps, direction change point P1, and direction change point P2 on cleaning path Ra in order.

At the timing at which discharge area U to which the coolant is discharged from nozzle 220A is located at first position Pm before direction change point P3, ATC is started. A command to pause discharging of the coolant due to the start of ATC is input to coolant control unit 281. Upon receipt of the command to pause discharging of the coolant due to the start of ATC, valve control unit 284 closes valve 76A.

As shown in FIG. 12, actuator control unit 285 drivingly rotates nozzle 220A such that discharge port 222 of nozzle 220A faces first position Pm, direction change point P3, and direction change point P2 on cleaning path Ra in order. Direction change point P2 corresponds to second position Pn on cleaning path Ra, which is a point as described in (ii) among (i) starting point Ps and (ii) a point located between starting point Ps and first position Pm. Direction change point P2 (second position Pn) is not starting point Ps but is located on the side closer to starting point Ps than to first position Pm. During this time, no coolant is discharged from nozzle 220A.

The process in actuator control unit 285 before and after the instruction to pause discharging of the coolant described above will be described in detail.

Actuator control unit 285 outputs, to motor driver 310A, the target rotation speed and the target rotation angle amount to move discharge area U, to which the coolant is discharged from nozzle 220A, from direction change point P2 to direction change point P3. Motor driver 310A applies a pulse signal corresponding to the input target rotation speed and target rotation angle amount to motor 231 (231J, 231K). When the timing at which the command to pause discharging of the coolant is input to coolant control unit 281 is in the middle of the application of the above pulse signal from motor driver 310A to motor 231, actuator control unit 285 detects a pause of discharging of the coolant at first position Pm between direction change point P2 and direction change point P3. Actuator control unit 285 completes the application of the above pulse signal irrespective of the pause of discharging of the coolant. As a result, discharge port 222 of nozzle 220A is drivingly rotated from the position facing direction change point P2 to the position facing direction change point P3 on cleaning path Ra.

Upon detection of a pause of discharging of the coolant at first position Pm between direction change point P2 and direction change point P3, actuator control unit 285 outputs, to motor driver 310A, the target rotation speed and the target rotation angle amount for reversely moving discharge area U, to which the coolant is discharged from nozzle 220A, from direction change point P3 to direction change point P2 (second position Pn). Motor driver 310A applies a pulse signal corresponding to the input target rotation speed and target rotation angle amount to motor 231. As a result, discharge port 222 of nozzle 220A is drivingly rotated from the position facing direction change point P3 to the position facing direction change point P2 (second position Pn) on cleaning path Ra.

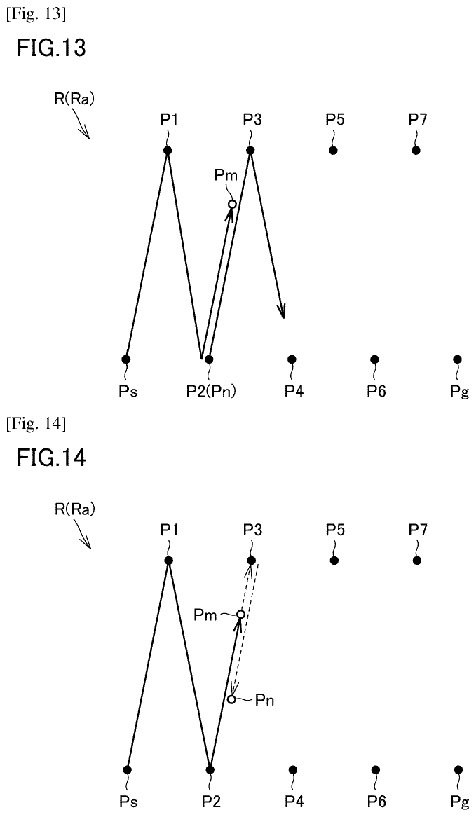

As shown in FIG. 13, valve control unit 284 opens valve 76A upon receipt of a command to resume discharging of the coolant due to the completion of ATC. Actuator control unit 285 drivingly rotates nozzle 220A such that discharge port 222 of nozzle 220A faces direction change point P2 (second position Pn), direction change point P3, direction change point P4, direction change point P5, direction change point P6, direction change point P7, and end point Pg on cleaning path Ra in order. As a result, with the coolant being discharged from nozzle 220A, discharge area U to which the coolant is discharged from nozzle 220A moves in a zigzag manner through direction change point P2 (second position Pn), direction change point P3, direction change point P4, direction change point P5, direction change point P6, direction change point P7, and end point Pg on cleaning path Ra in order. Valve control unit 284 closes valve 76A when discharge area U reaches end point Pg.

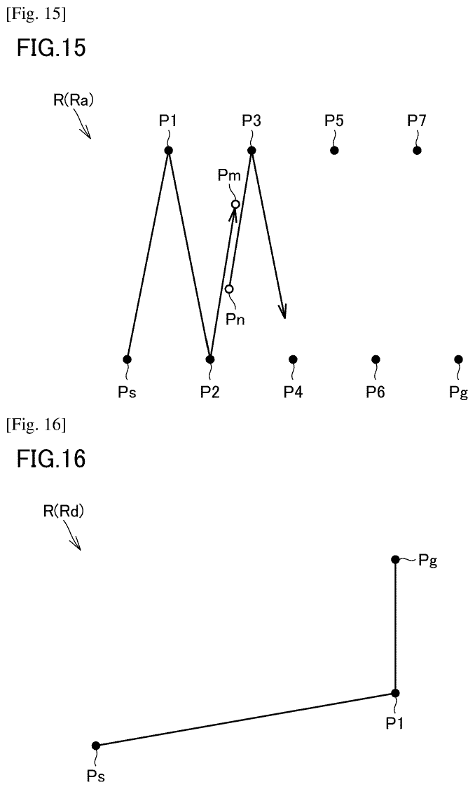

FIGS. 14 and 15 show a modification of the movement of the discharge area when automatic cleaning is paused and resumed in the cleaning path in FIG. 10.

Referring to FIGS. 14 and 15, in this modification, second position Pn at which discharging of the coolant from nozzle 220 is resumed is located, on cleaning path Ra, between starting point Ps and first position Pm and between direction change point P2 and first position Pm.

Second position Pn at which discharging of the coolant from nozzle 220 is resumed is not particularly limited as long as it is (i) starting point Ps or (ii) a point located between starting point Ps and first position Pm, and for example, it may be starting point Ps or direction change point P1.

FIG. 16 shows the cleaning path set in the fourth region. Referring to FIG. 16, cleaning path Rd is set in fourth region Sd. Cleaning path Rd extends through starting point Ps, direction change point P1, and end point Pg in order. Starting point Ps is the position at which cleaning path Rd begins. End point Pg is the position at which cleaning path Rd ends. Cleaning path Rd extends linearly from starting point Ps toward direction change point P1, changes its direction at direction change point P1, and extends linearly from direction change point P1 to end point Pg.

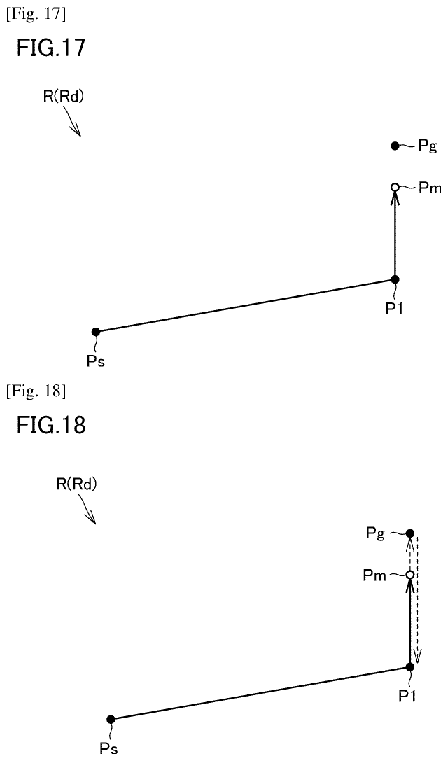

FIGS. 17 to 19 show the movement of the discharge area when automatic cleaning is paused and resumed in the cleaning path in FIG. 16.

Referring to FIGS. 17 to 19, actuator control unit 285 controls actuator 230 (motor 231) such that when discharging of the coolant from nozzle 220 (220B) is paused in the linear section between direction change point P1 and end point Pg, discharging of the coolant from nozzle 220 (220B) is resumed from direction change point P1.

As shown in FIG. 17, actuator control unit 285 drivingly rotates nozzle 220B such that discharge port 222 of nozzle 220B faces starting point Ps on cleaning path Rd. Valve control unit 284 opens valve 76B. Actuator control unit 285 drivingly rotates nozzle 220B such that discharge port 222 of nozzle 220B faces starting point Ps and direction change point P1 on cleaning path Rd in order. As a result, with the coolant being discharged from nozzle 220B, discharge area U to which the coolant is discharged from nozzle 220B moves through starting point Ps and direction change point P1 on cleaning path Rd in order.

At the timing at which discharge area U to which the coolant is discharged from nozzle 220B is located at first position Pm in the linear section between direction change point P1 and end point Pg, ATC is started. Upon receipt of a command to pause discharging of the coolant due to the start of ATC, valve control unit 284 closes valve 76B.

As shown in FIG. 18, actuator control unit 285 drivingly rotates nozzle 220B such that discharge port 222 of nozzle 220B faces first position Pm, end point Pg, and direction change point P1 on cleaning path Rd in order. Direction change point P1 corresponds to second position Pn on cleaning path Ra, which is a point as described in (ii) among (i) starting point Ps and (ii) a point located between starting point Ps and first position Pm. Direction change point P1 (second position Pn) is not starting point Ps and is located on the side closer to starting point Ps than to first position Pm. During this time, no coolant is discharged from nozzle 220B.

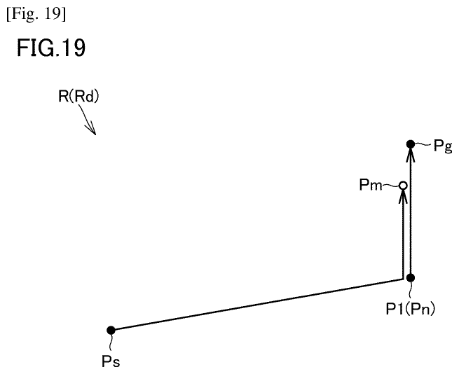

As shown in FIG. 19, upon receipt of a command to resume discharging of the coolant due to the completion of ATC, valve control unit 284 opens valve 76B. Actuator control unit 285 drivingly rotates nozzle 220B such that discharge port 222 of nozzle 220B faces direction change point P1 (second position Pn) and end point Pg on cleaning path Rd in order. As a result, with the coolant being discharged from nozzle 220B, discharge area U to which the coolant is discharged from nozzle 220B moves from direction change point P1 (second position Pn) to end point Pg on cleaning path Rd.

Also when ATC is executed during cleaning of a blind spot, discharging of the coolant from nozzle 215 is paused and resumed. In resuming cleaning of the blind spot, the execution time of cleaning may be reset.

Referring to FIGS. 1 and 7, coolant control unit 281 pauses/resumes discharging of the coolant from nozzles 220, 215 when the pause/resumption command is input by an operator's operation.

For example, the operator performs an operation to pause/resume discharging of the coolant from nozzles 220, 215 through operation panel 81. The operation may be performed using a button in the operation screen of machine tool 100 displayed on the touch screen of lower panel 83, or a button in the application screen for automatic cleaning displayed on the touch screen of upper panel 82. A command to pause discharging of the coolant is input to coolant control unit 281 when the operator operates the button for pausing discharging of the coolant, and a command to resume discharging of the coolant is input to coolant control unit 281 when the operator operates the button for resuming discharging of the coolant. When discharging of the coolant from nozzles 220, 215 is paused by an operator's operation, the spindle coolant included in tool spindle 21 may be continuously performed.

Since the coolant is vigorously discharged from nozzles 220, 215, a collision of the coolant and cover body 31 may cause a loud sound or cause the coolant to become atomized in machining area 110. The operator can pause discharging of the coolant from nozzles 220, 215 by operating operation panel 81 when checking the cutting sound caused by machining of the workpiece or visually checking the machining status of the workpiece in machining area 110.

Also when discharging of the coolant from nozzle 220 is paused/resumed by an operator's operation, actuator 230 is controlled by actuator control unit 285, as described with reference to FIGS. 10 to 19.

To summarize the configuration of machine tool 100 in the embodiment of the present invention described above, machine tool 100 in the present embodiment includes nozzle 220 that discharges a coolant to machining area 110, actuator 230 that operates nozzle 220, and actuator control unit 285 that controls actuator 230 such that discharge area U to which the coolant is discharged from nozzle 220 moves along cleaning path R serving as a predetermined path including starting point Ps and end point Pg and extending between starting point Ps and end point Pg. Actuator control unit 285 controls actuator 230 such that when discharging of the coolant from nozzle 220 is paused at first position Pm on cleaning path R, discharging of the coolant from nozzle 220 is resumed from second position Pn on cleaning path R, which is (i) starting point Ps or (ii) a point located between starting point Ps and first position Pm.

The information processor in the present embodiment is an information processor for controlling machine tool 100 including nozzle 220 that discharges a coolant to machining area 110 and actuator 230 that operates nozzle 220. The information processor includes actuator control unit 285 described above.

The control program in the present embodiment is a control program for machine tool 100 including nozzle 220 that discharges a coolant to machining area 110 and actuator 230 that operates nozzle 220. The control program causes machine tool 100 to perform the step of controlling actuator 230 such that discharge area U to which the coolant is discharged from nozzle 220 moves along cleaning path R including starting point Ps and end point Pg and extending between starting point Ps and end point Pg. The step of controlling actuator 230 includes the step of controlling actuator 230 such that when discharging of the coolant from nozzle 220 is paused at first position Pm on cleaning path R, discharging of the coolant from nozzle 220 is resumed from second position Pn on cleaning path R which is (i) starting point Ps or (ii) a point located between starting point Ps and first position Pm.

A computer-readable storage medium in the present embodiment records a control program for machine tool 100 including nozzle 220 that discharges a coolant to machining area 110 and actuator 230 that operates nozzle 220. The control program causes machine tool 100 to perform the step of controlling actuator 230 such that discharge area U to which the coolant is discharged from nozzle 220 moves along cleaning path R including starting point Ps and end point Pg and extending between starting point Ps and end point Pg. The step of controlling actuator 230 includes the step of controlling actuator 230 such that when discharging of the coolant from nozzle 220 is paused at first position Pm on cleaning path R, discharging of the coolant from nozzle 220 is resumed from second position Pn on cleaning path R, which is (i) starting point Ps or (ii) a point located between starting point Ps and first position Pm. The computer-readable storage medium may be a non-transitory computer-readable storage medium.

With this configuration, since discharging of the coolant from nozzle 220 is resumed from second position Pn on cleaning path R which is (i) starting point Ps or (ii) a point located between starting point Ps and first position Pm, the section on cleaning path R to which the coolant is discharged overlaps between before pause and after resumption of discharging of the coolant Thus, sufficient cleaning effects can be obtained in all sections along cleaning path R irrespective of the pause of discharging of the coolant. Further, when second position Pn is (ii) a point located between starting point Ps and first position Pm, the step of cleaning machining area 110 with the coolant can be performed efficiently.

Machine tool 100 further includes camera 210 for capturing an image of machining area 110 and chip recognition unit 283 that recognizes an accumulation area where chips are accumulated based on the image captured by camera 210. Actuator control unit 285 controls actuator 230 such that discharge area U moves along cleaning path R set in the accumulation area recognized by chip recognition unit 283.

In this configuration, discharging of the coolant from nozzle 220 can be resumed without performing again the imaging step by camera 210 and the step of recognizing the chip accumulation area by chip recognition unit 283, further efficiently performing the step of cleaning machining area 110 with the coolant.

Machine tool 100 includes a plurality of sets of nozzles 220 and actuators 230. Actuator control unit 285 can control actuator 230 for each set of the plurality of sets of nozzles 220 and actuators 230.

With this configuration, the above step of pausing/resuming discharging of the coolant from nozzle 220 is performed in each of the cleaning step by nozzle 220A and the cleaning step by nozzle 220B. This obtains the effect that the step of cleaning machining area 110 with the coolant is performed in such a way that sufficient cleaning effects are obtained in each of the cleaning step by nozzle 220A and the cleaning step by nozzle 220B.

Although the present embodiment has described cleaning path Ra and cleaning path Rd, each of which is a combination of a plurality of linear paths, the configuration of cleaning path R corresponding to a predetermined path in the present invention is not particularly limited. Cleaning path R may be a single linear path, a single curved path, or a combination of a plurality of curved paths having curvatures different from each other. Cleaning path R may be a combination of any number of linear paths and any number of curved paths.

When cleaning path R includes a single linear path, one end of the linear path corresponds to starting point Ps, and the other end of the linear path corresponds to end point Pg. When cleaning path R includes a single curved path, one end of the curved path corresponds to the starting point, and the other end of the curved path corresponds to the end point. In these cases, second position Pn may be starting point Ps, may not be starting point Ps but may be positioned on the side closer to starting point Ps than to first position Pm, may be an intermediate position between starting point Ps and first position Pm, or may be a position on the side further closer to starting point Ps than to the intermediate position.

Assumed here is cleaning path R in which a first path and a second path are arranged in order along the direction of movement of discharge area U. Apart from the present invention, an invention may be configured in which, when discharging of the coolant is paused at first position Pm located in the middle of the first path, discharging of the coolant is resumed from second position Pn located at the beginning of the second path.

The machine tool in the present invention is not limited to a horizontal machining center, and may be, for example, a vertical machining center, a lathe, a multitasking machine having a turning function and a milling function, or an additive manufacturing (AM)/subtractive manufacturing (SM) hybrid machine capable of both the AM machining and the SM machining of workpieces.

It should be understood that the embodiment disclosed herein has been presented for the purpose of illustration and non-restrictive in every respect. It is therefore intended that the scope of the present invention is defined by claims, rather than the description above, and encompasses all modifications and variations equivalent in meaning and scope to the claims.

This nonprovisional application is based on Japanese Patent Application No. 2023-140031 filed on Aug. 30, 2023, with the Japan Patent Office, the entire contents of which are hereby incorporated by reference.

### REFERENCE SIGNS LIST

21 tool spindle; 22 cross slide; 23 column; 31 cover body; 32 first cover; 33 second cover; 34 telescopic cover; 35 door; 36 first oil pan; 37 second oil pan; 38 shutter; 39 ceiling cover; 41 table; 42 pallet; 46 conveyor; 50 automatic pallet changer; 51 turning cover; 52 APC arm; 61 automatic tool changer; 71 coolant tank; 72 pump; 76, 76A, 76B, 78 valve; 81 operation panel; 82 upper panel; 83 lower panel; 100 machine tool; 101 rotation center axis; 102 turning center axis; 110 machining area; 120 setup station; 210 camera; 215, 220, 220A, 220B nozzle; 222 discharge port; 226 pin member; 230 actuator; 231, 231J, 231K motor; 232 output shaft; 241, 246 belt; 242, 247 long hole; 251 controller; 271 CPU unit; 272 CNC unit; 273 communication path; 281 coolant control unit; 282 image acquisition unit; 283 chip recognition unit; 284 valve control unit; 285 actuator control unit; 291 storage device; 293 path storage unit; 294 learned model storage unit; 310, 310A, 310B motor driver; 320, 330, 340 servo driver; 321, 331, 341 servo motor; M learned model; P1, P2, P3, P4, P5, P6, P7 direction change point; Pg end point; Pm first position; Pn second position; Ps starting point; R, Ra, Rb, Rd cleaning path; S region; Sa first region; Sb second region; Sc third region; Sd fourth region; Se fifth region; Sf sixth region; Sg seventh region; Sh eighth region; T path table; U discharge area; W workpiece.

1. A machine tool comprising:
a nozzle that discharges a coolant to a machining area;
an actuator that operates the nozzle; and
an actuator control unit that controls the actuator such that a discharge area to which the coolant is discharged from the nozzle moves along a predetermined path including a starting point and an end point and extending between the starting point and the end point,
wherein when discharging of the coolant from the nozzle is paused at a first position on the predetermined path, the actuator control unit controls the actuator such that discharging of the coolant from the nozzle is resumed from a second position on the predetermined path, the second position being (i) the starting point or (ii) a point located between the starting point and the first position.

2. The machine tool according to claim 1, wherein
the predetermined path further includes a plurality of direction change points located between the starting point and the end point and extends in a zigzag manner while changing a direction at each of the plurality of direction change points, and
when discharging of the coolant from the nozzle is paused between a first direction change point and a second direction change point contiguous to the first direction change point among the plurality of direction change points, the actuator control unit controls the actuator such that discharging of the coolant from the nozzle is resumed from the first direction change point.

3. The machine tool according to claim 1, wherein
the predetermined path further includes a direction change point located between the starting point and the end point and a linear section located between the direction change point and the end point, and the predetermined path changes a direction at the direction change point and extends linearly in the linear section, and
when discharging of the coolant from the nozzle is paused in the linear section, the actuator control unit controls the actuator such that discharging of the coolant from the nozzle is resumed from the direction change point.

4. The machine tool according to claim 1, further comprising:
a camera for capturing an image of the machining area; and
a chip recognition unit that recognizes, based on the image captured by the camera, an accumulation area in which chips are accumulated,
wherein the actuator control unit controls the actuator such that the discharge area moves along the predetermined path set in the accumulation area recognized by the chip recognition unit.

5. The machine tool according to claim 1, further comprising a plurality of sets of the nozzles and the actuators,
wherein the actuator control unit is capable of controlling the actuator for each set of the plurality of sets of nozzles and actuators.

6. The machine tool according to claim 1, further comprising a coolant control unit for controlling discharging of the coolant from the nozzle,
wherein upon input of a command to pause/resume discharging of the coolant based on a machining program or a command to pause/resume discharging of the coolant by an operator's operation, the coolant control unit pauses/resumes discharging of the coolant from the nozzle.

7. An information processor for controlling a machine tool including a nozzle that discharges a coolant to a machining area and an actuator that operates the nozzle,
the information processor comprising an actuator control unit that controls the actuator such that a discharge area to which the coolant is discharged from the nozzle moves along a predetermined path including a starting point and an end point and extending between the starting point and the end point,
wherein when discharging of the coolant from the nozzle is paused at a first position on the predetermined path, the actuator control unit controls the actuator such that discharging of the coolant from the nozzle is resumed from a second position on the predetermined path, the second position being (i) the starting point or (ii) a point located between the starting point and the first position.

8. A non-transitory computer readable storage medium configured to store a control program for a machine tool including a nozzle that discharges a coolant to a machining area and an actuator that operates the nozzle,
the control program causes the machine tool to perform the step of controlling the actuator such that a discharge area to which the coolant is discharged from the nozzle moves along a predetermined path including a starting point and an end point and extending between the starting point and the end point, the step of controlling the actuator including the step of controlling the actuator such that when discharging of the coolant from the nozzle is paused at a first position on the predetermined path, discharging of the coolant from the nozzle is resumed from a second position on the predetermined path, the second position being (i) the starting point or (ii) a point located between the starting point and the first position.

9. The machine tool according to claim 1, wherein
the actuator includes a stepping motor for drivingly rotating the nozzle.
